(19) United States
(12) Patent Application Publication
(10) Pub. No.: US 2026/0281220 A1
(43) Pub. Date: Sep. 17, 2026

(54) Electronic Devices With Displays and Camera Windows

(71) Applicant: Apple Inc., Cupertino, CA (US)

(72) Inventors: Lee E Hooton, Massapequa, NY (US); Jia Liu, San Jose, CA (US); Paul Choiniere, Livermore, CA (US); Daniel W Jarvis, Sunnyvale, CA (US)

(21) Appl. No.: 19/676,461

(22) Filed: May 13, 2026

Related U.S. Application Data
(63) Continuation of application No. 18/364,855, filed on Aug. 3, 2023, now Pat. No. 12,665,962.
(60) Provisional application No. 63/407,024, filed on Sep. 15, 2022.

(51) Int. Cl. H04M 1/02

(52) U.S. Cl. CPC H04M 1/0264; H04M 1/0268; H04M 1/0277

(57) ABSTRACT

Electronic devices may be provided with components such as displays and cameras. A display may be mounted in a housing. The housing may have a sidewall. A bent portion of the display may be embedded in epoxy that is separated from the sidewall by an air gap. Adhesive may attach the epoxy to the housing. A metal support that is chemically bonded to the epoxy may be welded to metal structures such as camera brackets and other metal supports. The housing may have a glass layer that forms a rear wall. The glass layer may have a protruding portion that forms a glass plateau with openings through which cameras operates. A camera may have a protruding portion that is received within one of the glass plateau openings. The protruding portion may extend into a metal camera trim in one of the openings that is attached to the glass plateau.

This application is a continuation of U.S. patent application No. 18/364,855, filed August 3, 2023, which claims the benefit of provisional patent application No. 63/407,024, filed September 15, 2022, which are hereby incorporated by reference herein in their entireties.

### FIELD

This relates generally to electronic devices, and, more particularly, to electronic devices with displays and camera windows.

### BACKGROUND

Electronic devices such as cellular telephones include displays and cameras. Displays may be mounted under display cover layers. Cameras may be mounted under camera windows.

### SUMMARY

Electronic devices may be provided with components such as displays and cameras. A display may be mounted in an electronic device housing. A bent tail of the display may be embedded in epoxy that is separated from a housing sidewall by an air gap.

Adhesive may attach the epoxy to the housing. A metal support that is chemically bonded to the epoxy may be welded to metal structures such as camera brackets and other metal supports.

The housing may have a glass layer that forms a rear wall. The glass layer may have a protruding portion that forms a glass plateau with openings to receive cameras. A camera may have a protruding portion that is received within one of the glass plateau openings. The protruding portion may extend into a metal camera trim in one of the openings that is attached to the glass of the plateau with epoxy sealant.

A packaged circuit for the electronic device may include multiple printed circuits populated with integrated circuits and other components. The printed circuits may be attached to each other using epoxy encapsulant that covers the integrated circuits.

### BRIEF DESCRIPTION OF THE DRAWINGS

FIG. 1 is a perspective view of an illustrative electronic device in accordance with an embodiment.

FIG. 2 is a cross-sectional side view of a portion of an electronic device with a display in accordance with an embodiment.

FIG. 3 is a side view of a portion of an illustrative electronic device in accordance with an embodiment.

FIG. 4 is a cross-sectional view of the illustrative electronic device of FIG. 3 in accordance with an embodiment.

FIG. 5 is a cross-sectional view of a portion of an illustrative electronic device with an epoxy housing seal in accordance with an embodiment.

FIG. 6 is a rear view of an illustrative electronic device having a glass rear housing wall with a protruding glass plateau in which openings for cameras are formed in accordance with an embodiment.

FIG. 7 is a cross-sectional side view of a portion of an illustrative electronic device with a camera window in a glass housing wall in accordance with an embodiment.

FIG. 8 is a cross-sectional side view of an illustrative packaged set of printed circuit boards populated with integrated circuits and other components in accordance with an embodiment.

### DETAILED DESCRIPTION

An electronic device may be provided with a display. The display may, as an example, be mounted on a front surface of the electronic device. The electronic device may also have optical components such as cameras. The cameras may operate through camera windows. The camera windows may be formed from openings in a rear housing wall such as a rear glass layer. Sealing and support structures around the display and camera windows and elsewhere in the electronic device may be formed from polymers such as epoxy. The epoxy may be handled at relatively low temperatures and pressures and can form chemical bonds for sealing to glass and metal parts. The epoxy may be used to encapsulate a display tail, may be used as a housing seal that attaches housing structures together, may be used as an integrated circuit encapsulant in a packaged circuit, may be used as sealant to attach a camera trim to a housing wall, may be used to form an epoxy-filled slit between peripheral conductive housing sidewall segments, and/or may be used elsewhere in the electronic device.

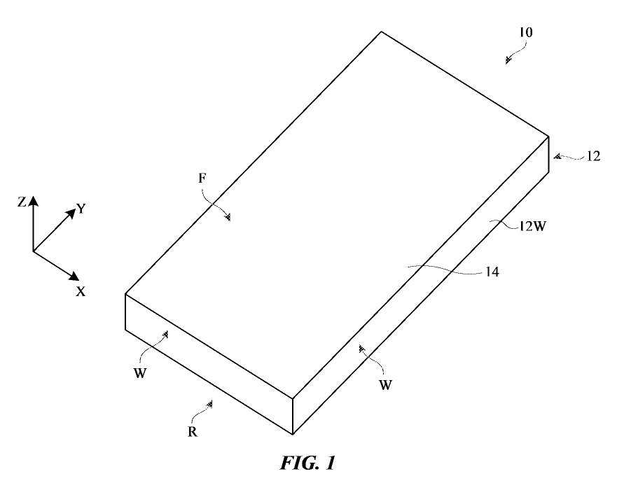

FIG. 1 is a perspective view of an illustrative electronic device. Electronic device 10 of FIG. 1 has a front such as front F, an opposing rear such as rear R, and surrounding sides W. Display 14 may be mounted to housing 12 on front F. Housing 12 may be formed from housing walls and other structures of metal, polymer, glass, ceramic, other materials, and/or combinations of these materials. In the illustrative arrangement of FIG. 1, housing 12 includes a peripheral side wall portion 12W that runs around the periphery of device 10. Housing 12 may include a rear housing wall on rear R (e.g., a housing wall formed from glass and/or other suitable housing wall materials). In general, any suitable electronic device may have housing and display structures such as these (e.g., a laptop computer, a wristwatch, a tablet computer, a head-mounted device, etc.). Illustrative configurations in which device 10 of FIG. 1 is a cellular telephone may sometimes be described herein as an example.

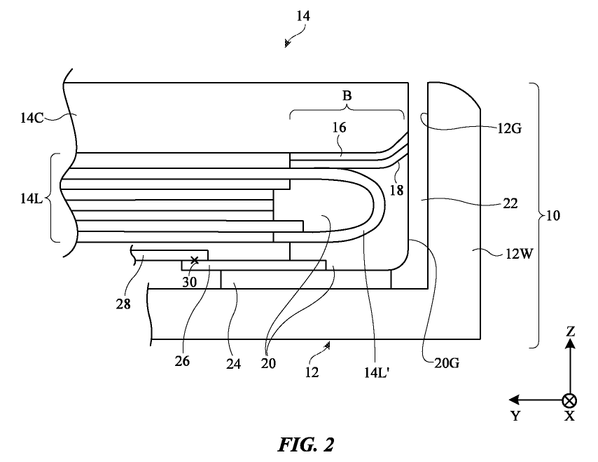

FIG. 2 is a cross-sectional side view of an edge portion of device 10. As shown in FIG. 2, display 14 may include a display panel such as display panel 14L. Panel 14L may include one or more display layers such as a polarizer, a substrate on which thin-film transistor circuitry and thin-film organic light-emitting diode pixels are formed, etc. These display layers may form a pixel array that is configured to display images. The images may be viewed through a transparent protective layer such as display cover layer 14C (sometimes referred to as an upper housing wall or transparent housing wall) that overlaps the layers of panel 14L. A flexible tail portion of display 14 such as tail 14L’ may be wrapped back on itself in order to route signal lines on the tail portion to integrated circuits in the interior of device 10. During operation, display driver circuitry and/or other control circuitry in device 10 can supply image data to the pixels of panel 14L over the signal lines on tail 14L’. Tail 14L’ may be formed from an integral portion of a display substrate layer in panel 14L (e.g., a polyimide substrate).

To support and protect the edge of display panel 14L, a ring formed from polymer 20 may be formed around the rectangular periphery of panel 14L. This polymer ring may run parallel to the rectangular periphery of front F of device 10. Along the edge of panel 14L that includes tail 14L’, some of polymer 20 is formed inside the bent portion of tail 14L’ and some of the polymer 20 is formed outside of the bent portion of tail 14L’. Surrounding tail 14L’ with polymer 20 and thereby embedding tail 14L’ within polymer 20 in this way helps support and protect tail 14L’.

In addition to using polymer 20 to support tail 14L’, polymer 20 may be used as a seal that attaches housing structures together, may form an integrated circuit encapsulant that encapsulates integrated circuits on printed circuit boards while attaching the circuit boards together to form a packaged circuit, may form a gap-filling structure that attaches housing sidewall segments together, may form a seal that attaches a camera trim to a glass housing wall, and/or may be used in supporting and attaching other structures within device 10. To prevent damage to potentially sensitive structures in device 10 (e.g., to prevent damage to display layers in panel 14L) and to help attach polymer 20 to structures in device 10, polymer 20 may be formed from a thermoset polymer such as epoxy. Epoxy can be cured using light or heat. In an illustrative configuration, polymer 20 may be applied using a low injection pressure (e.g., a pressure of less than 0.5 MPa) at room temperature (e.g., 20^{o}C). Injection molding of thermoplastic polymers typically involves injection pressures of over 150 MPa and temperatures of over 60^{o}C. By using lower temperatures and pressures to mold polymer 20 into its desired ring shape (e.g., temperatures below 40^{o}C, below 30^{o}C, etc. and pressures below 100 MPa, below 20 MPa, below 3 MPa, below 1 MPa, etc.) damage to thin metal support structures and other potentially sensitive structures within device 10 can be avoided.

By using light-based curing for polymer 20, thermal expansion and contraction effects can be avoided. To support light-based curing arrangements, the epoxy is provided with a photoinitiator that is sensitive to light. When light is applied, epoxy curing is initiated due to the presence of the photoinitiator. The photoinitiator may be sensitive to ultraviolet and/or visible light. In an illustrative configuration, the material of tail 14L’ (e.g., polyimide) is transparent to blue visible light at a wavelength of about 450 nm to 470 nm (e.g., less than 60% of light at this wavelength is absorbed when passing through tail 14L’). By incorporating a photoinitiator into the epoxy of polymer 20 that is sensitive to light with a wavelength of 450 nm to 470 nm (or other suitable light such as light with a wavelength between 430 nm and 490 nm), light can pass through tail 14L’ during curing, thereby helping to ensure that the portion of polymer 20 that lies within the bent portion of tail 14L’ will not be shadowed by tail 14L’ and will therefore be cured satisfactorily. Light of a shorter wavelength (e.g., ultraviolet light) may be prone to absorption in tail 14L’, which could lead to uneven curing of polymer 20.

The peripheral edge of display 14 may be provided with a ring-shaped opaque border B. Border B may be formed by depositing one or more opaque (e.g., black) layers of ink 16 on the underside of layer 14C around the periphery of display 14. Ink 16 may be formed from polyester or other polymer with opaque colorant (e.g., black dye and/or pigment). Ink 16 may be covered with a layer of epoxy such as layer 18. Layer 18 may be a thermally cured clear epoxy that is cured as part of a high temperature curing process used for curing ink 16. The presence of layer 18 helps promote subsequent adhesion between polymer 20 and border B.

Polymer 20 may have an outwardly-facing side surface such as surface 20G and the inner side of housing sidewall 12W may have an opposing inwardly-facing side surface such as surface 12G. Surfaces 20G and 12G may be separated by air gap 22. Air gap 22 may also separate the side surface of layer 14C from sidewall 12W. During high stress conditions such as drop events, the presence of gap 22 helps prevent hard contact between polymer 20 and sidewall 12W and helps prevent hard contact between layer 14C and sidewall 12W, thereby helping to prevent damage during drop events.

Polymer 20 may be attached to the surface of housing 12 using adhesive 24. Adhesive 24 may be, for example, a pressure sensitive adhesive such as an acrylic adhesive. Adhesive 24 may have a ring shape that runs along the ring-shaped peripheral edge of device 10.

A metal support such as metal support 26 (e.g., a support forming all or part of a metal ring that runs along the inner edge of device 10) may be attached to adhesive 24 and may serve as a support for internal structures in the interior of device 10. These internal structures may include mounting structures such as support 28 (e.g., a camera bracket, a support for a sensor, and/or a support for other components in device 10). Supports such as support 28 may be welded to support 26 using welds such as weld 30.

If desired, polymer 20 (e.g., epoxy or other thermoset polymer molded and cured using low temperatures and/or pressures) may be used in forming seals, encapsulant, gap-filling structures, dielectric windows, and/or other structures in device 10.

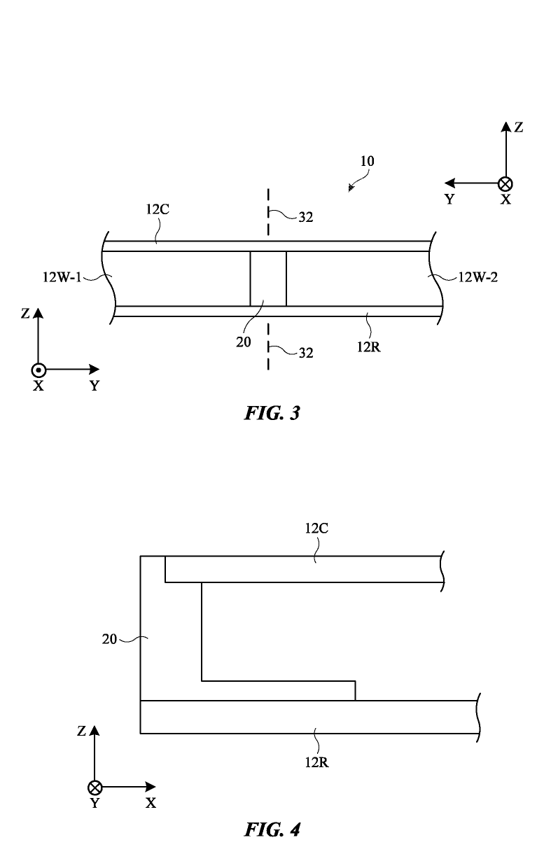

In the example of FIG. 3, polymer 20 is used in forming a slit-filling structure and bond between two opposing peripheral housing wall segments such as segment 12W-1 and 12W-2 that are separated by a slit (gap). Segments 12W-1 and 12W-2 may be formed in a peripheral conductive housing sidewall (metal sidewall) of device 10 that allows these segments to serve as antenna resonators. Polymer 20 may form chemical bonds with stainless steel and/or other metal or material(s) used in forming housing 12. As shown in the side view of device 10 of FIG. 3, display cover layer 12C may be mounted on front F (FIG. 1) and a rear housing wall formed from a layer of glass or other material such as rear wall layer 12R may be mounted on rear R (FIG. 1). FIG. 4 shows a cross-sectional view of device 10 of FIG. 3 taken along line 32. At the interfaces between polymer 20 and housing structures such as sidewall 12W, layer 12C, and layer 12R of FIGS. 3 and 4, chemical bonds may be formed between the epoxy of polymer 20 and the glass, metal, and/or other material of sidewall 12W, layer 12C, and layer 12R. These chemical bonds form seals that resist moisture ingress without requiring additional application of polymer sealant coatings. If desired, polymer 20 may form a window (e.g., a radio-transparent antenna window) in an opening in a metal housing sidewall portion of housing 12 or in another opening in a conductive structure in device 10.

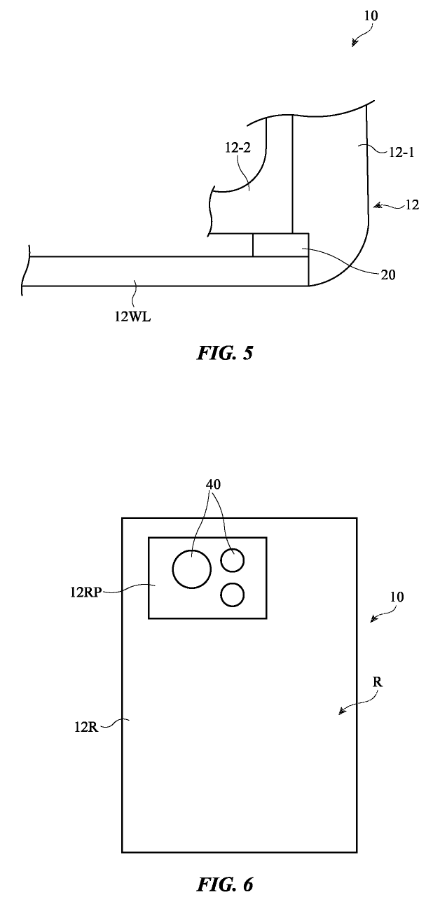

FIG. 5 is a cross-sectional side view of another illustrative housing and seal arrangement for device 10. As shown in the cross-sectional side view of the portion of device 10 of FIG. 5, housing 12 may have portions such as inner portion 12-2 and outer portion 12-1. As with other portions of housing 12, portions 12-1 and 12-2 may be formed from metal (e.g., stainless steel, aluminum, etc.), may be formed from glass, may be formed from polymer, may be formed from ceramic and/or other material, and/or may be formed from a combination of two or more of these materials. Portions 12-1 and 12-2, which may form a housing wall or other housing structure may be attached to housing wall 12WL (e.g., layer 12R, layer 12C, etc.) using a seal formed from epoxy (polymer 20 of FIG. 5). In this arrangement, chemical bonds may be formed between polymer 20 and portions 12-1 and 12-2 and wall 12WL, thereby forming a moisture-tight seal without requiring application of additional polymer sealant coatings. In general, polymer 20 (e.g., epoxy) may be used in forming seals between any adjacent portions of housing 12 and/or other structures in device 10. The example of FIG. 5 is illustrative.

If desired, device 10 may have optical windows such as camera windows 40 of FIG. 6. Windows 40 may be formed in region 12RP of layer 12R. Layer 12R may be formed from a material such as glass and, in an illustrative configuration, region 12RP may be formed from a protruding portion of the glass of layer 12R (e.g., a protruding glass plateau).

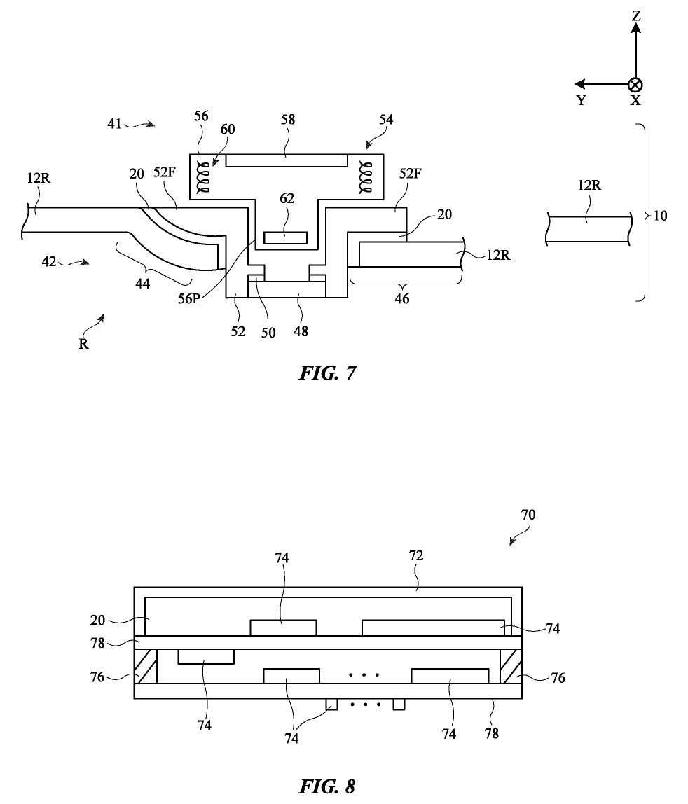

FIG. 7 is a cross-sectional side view of an illustrative camera window arrangement for device 10 that uses polymer 20 for sealing and that uses a protruding plateau in layer 12R to provide enhanced amounts of interior volume in device 10 for camera resources. As shown in FIG. 7, camera 54 may be mounted in an opening in a housing wall in device 10. In the example of FIG. 7, this housing wall is formed by layer 12R on rear R. Layer 12R (e.g., a glass layer) may separate interior region 41 of device 10 from exterior region 42, which surrounds device 10. Camera 54 may have a housing such as camera housing 56. Camera components such as image sensor 58, lens 62, and lens focusing coils 60, may be mounted in housing 56.

Layer 12R has an opening that receives camera window trim 52. Trim 52 may, as an example, be formed from metal (e.g., stainless steel). A transparent protective camera window cover such as cover 48 (e.g., a layer of glass, sapphire or other crystalline material, polymer, etc.) may be mounted to trim 52. For example, trim 52 may have a ledge to which cover 48 is attached with adhesive 50. In this type of arrangement, polymer 20 may be used as sealing polymer that forms chemical bonds with trim 52 and layer 12R, thereby helping to form a moisture-tight seal that prevents moisture ingress into interior 41 from exterior 42.

The focusing performance and image quality of camera 54 can be adversely affected when insufficient vertical space (distance along the Z axis) is available for coils 60 and housing protrusion 56P. With the arrangement of FIG. 7, the amount of vertical space for camera 54 in interior region 41 is enhanced by creating an outward bulge in layer 12R. As shown in FIG. 7, portions 44 and 46 of layer 12R may protrude outwardly from the rest of layer 12R in the -Z direction. For example, portion 44 of layer 12R may have a bent shape that allows layer 12R to transition between the main portion of layer 12R and a protruding plateau (portion 46). In an illustrative configuration, protruded portion 46 forms a plateau in layer 12R that is at a location that protrudes in the -Z direction from the rest of layer 12R by at least 0.1 mm, at least 0.2 mm, at least 0.4 mm, at least 0.6 mm, at least 0.8 mm, at least 1.0 mm, at least 1.2 mm, at least 1.4 mm, at least 1.6 mm, at least 1.8 mm, less than 4 mm, less than 3.5 mm, less than 3 mm, less than 2.5 mm, less than 2.2 mm, less than 2.0 mm, less than 1.7 mm, less than 1.5 mm, by 0.5-3 mm, by 0.5-2 mm, by 1-3 mm, or other suitable plateau protrusion amount. There may be any suitable number of camera windows in the protruding plateau formed in layer 12R (e.g., at least one, at least two, at least three, one to four, etc.).

FIG. 8 is a cross-sectional side view of an illustrative packaged circuit having multiple printed circuit boards that are attached to each other using polymer 20. Polymer 20 may also serve as an encapsulant for components on the printed circuit boards. As shown in FIG. 8, packaged circuit 70 may include electrical components 74 such as integrated circuits including processors (e.g., a microprocessor, digital signal processor, power management unit, baseband processor, etc.), storage (e.g., dynamic and static random access memory, solid state drive storage, etc.), and/or other integrated circuits, may include discrete components (capacitors, resistors, and inductors), and may include other circuits (e.g., sensors, etc.). Components 74 may be mounted to printed circuit boards 78 (e.g., rigid printed circuit boards formed from fiberglass-filled epoxy or other rigid printed circuit board substrate material). Spacers 76 may include signal paths to couple the signal paths of a first of printed circuit boards 78 to a second of printed circuit boards 78 that is stacked on top of the first board. Optional electromagnetic shielding 72 may be formed over some or all of components 74. Shielding 72 may be a stamped sheet metal structure, may be formed from a metal coating on polymer 20, and/or may be formed from other conductive material. Magnetic shielding may be formed by including ferrite or other magnetic material in shielding 72. To help dissipate heat generated by components 74, polymer 20 of packaged circuit 70 of FIG. 8 may include metal particles and/or other thermally conductive filler to enhance the thermal conductivity of polymer 20.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. An electronic device having an interior and an exterior, the electronic device comprising:
a housing including a housing wall with a protruding portion forming a plateau with an opening;
a camera configured to operate through the opening;
a camera trim in the opening, wherein a portion of the camera protrudes into the camera trim; and
a molded polymer that attaches the camera trim to the plateau, wherein the molded polymer separates the interior from the exterior.

2. The electronic device of claim 1, wherein the camera trim is a metal camera trim.

3. The electronic device of claim 2, wherein the camera trim is formed from stainless steel.

4. The electronic device of claim 2, wherein the electronic device has a front and an opposing rear, the electronic device further comprising a display mounted at the front.

5. The electronic device of claim 4, wherein the housing wall is at the rear and wherein the plateau protrudes outwardly from the housing wall.

6. The electronic device of claim 5, wherein the plateau protrudes from the housing wall by 0.5-3 mm.

7. The electronic device of claim 4, wherein the display has a bent tail embedded in epoxy.

8. The electronic device of claim 1, wherein the molded polymer is a thermoset polymer.

9. The electronic device of claim 8, wherein the thermoset polymer is an epoxy sealant.

10. The electronic device of claim 9, wherein the epoxy sealant comprises a photoinitiator.

11. The electronic device of claim 1, wherein the housing wall is a first housing wall, the electronic device further comprising:
a second housing wall that is adjacent to the first housing wall; and
additional molded polymer that bonds the first housing wall to the second housing wall.

12. The electronic device of claim 1, further comprising:
first and second printed circuit boards in the housing; and
additional molded polymer that bonds the first printed circuit board to the second printed circuit board.

13. The electronic device of claim 1, further comprising:
a printed circuit board in the housing; and
additional molded polymer that encapsulates components on the printed circuit board.

14. An electronic device having an interior and an exterior, the electronic device comprising:
a housing including a first housing wall and a second housing wall that is adjacent to the first housing wall, wherein the first housing wall is separated from the first housing wall by a slit; and
a molded polymer that fills the slit between the first and second housing walls and that bonds the first housing wall to the second housing wall, wherein the molded polymer separates the interior from the exterior.

15. The electronic device of claim 14, wherein the electronic device has a front and an opposing rear, the electronic device further comprising a display mounted at the front.

16. The electronic device of claim 15, wherein the first housing wall is at the rear, and the second housing wall extends from the front to the rear.

17. The electronic device of claim 16, wherein the first housing wall includes a protruding portion forming a plateau with an opening, the electronic device further comprising:
a camera configured to operate through the opening;
a camera trim in the opening, wherein a portion of the camera protrudes into the camera trim; and
additional molded polymer that attaches the camera trim to the plateau, wherein the molded polymer separates the interior from the exterior.

18. An electronic device having an interior and an exterior, the electronic device comprising:
a housing including a housing wall with a protruding portion forming a plateau with an opening;
a camera configured to operate through the opening;
a camera trim in the opening, wherein a portion of the camera protrudes into the camera trim; and
epoxy that attaches the camera trim to the plateau, wherein the epoxy separates the interior from the exterior, and the epoxy includes a photoinitiator.

19. The electronic device of claim 18, wherein the photoinitiator is sensitive at a wavelength between 450 nm and 490 nm.

20. The electronic device of claim 18, wherein the housing wall is a first housing wall, the electronic device further comprising:
a second housing wall that is adjacent to the first housing wall; and
molded polymer that bonds the first housing wall to the second housing wall.
